(19) United States
(12) Patent Application Publication
(10) Pub. No.: US 2012/0051986 A1
(43) Pub. Date: Mar. 1, 2012

(54) RACK CONFIGURED TO SUPPORT VIALS WITH IDENTIFICATION INDICIA EXPOSED

(75) Inventors: Natalie Pavlova, Medford, NJ (US); Donald Carter, New Castle, DE (US); Douglas Grady, Vineland, NJ (US)

(73) Assignee: Wheaton Industries, Inc., Millville, NJ (US)

(21) Appl. No.: 12/872,524

(22) Filed: Aug. 31, 2010

(51) Int. Cl. B01L 9/06

(52) U.S. Cl. 422/562

(57) ABSTRACT

A vial storage rack for storing vials having a base. The storage rack includes a support surface and support members positioned relative to the support surface to define a plurality of vial receptacles. Each vial receptacle is sized to receive and support a respective vial base. An opening is defined through the support surface in each vial receptacle. Each opening has a size smaller than the size of the vial base.

The present invention relates to vials. More particularly, the present invention relates to a rack for supporting a plurality of vials having identification indicia exposed for scanning or reading.

### BACKGROUND OF THE INVENTION

The growing need to collect and store a wide range of biological samples for research has led to the creation of biorepositories. To ensure the viability of biospecimens being stored in biorepositories over long periods, the samples are placed in sterile plastic or glass vials and then immersed into the vapor phase of Liquid Nitrogen (LN2).

Storage racks have been developed to store a large number of these vials. With the increase in the number of stored biological samples, it becomes increasingly important to effectively identify and track the vials. While identification indicia may be applied to the vials, prior art racks have made it difficult to easily read or scan vials without first removing them from the rack.

### SUMMARY OF THE INVENTION

In at least one embodiment, the present invention provides a vial storage rack for storing vials having a base. The storage rack includes a support surface and support members positioned relative to the support surface to define a plurality of vial receptacles. Each vial receptacle is sized to receive and support a respective vial base. An opening is defined through the support surface in each vial receptacle. Each opening has a size smaller than the size of the vial base.

### BRIEF DESCRIPTION OF THE DRAWINGS

FIG. 1 is a perspective view of an exemplary vial and cap assembly for use with the storage rack in accordance with an embodiment of the present invention.

FIG. 2 is a perspective view of a storage rack in accordance with an embodiment of the present invention.

FIG. 3 is a top plan view of the storage rack of FIG. 2.

FIG. 4 is a cross-sectional view along the line 4-4 in FIG. 3.

FIG. 4A is an expanded view of a portion of the storage rack shown in FIG. 4.

FIG. 5 is a cross-sectional view along the line 5-5 in FIG. 3.

FIG. 6 is an expanded view of one of the support members of the storage rack as illustrated in FIG. 3.

FIG. 7 is a cross-sectional view along the line 7-7 in FIG. 6.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

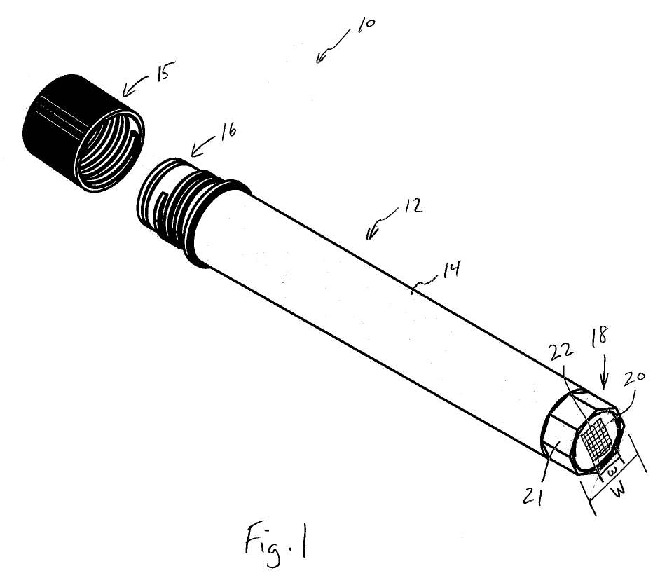

Referring to FIG. 1, an exemplary cryogenic vial and cap assembly 10 will be described. While the storage rack 50 of the present invention is described with respect to this cryogenic vial and cap assembly 10, the invention is not limited to such and may be used with various vial assemblies. The exemplary assembly 10 generally includes a vial 12 and a cap 15. The vial 12 has a generally tubular body 14 extending between an open end 16 and a base 18. The base 18 is configured to support the vial 12 in a standing position. The base 18 may include a series of flat surfaces 21 which contact surfaces of the storage rack 50, as described hereinafter, to hold the vial 12 against rotation which may assist in cap securing or removal.

The base 18 includes a base surface 20 which is opposite the vial open end 16. The base surface 20 has an identification indicia 22 thereon. The identification indicia 22 may be for example a 2D data matrix bar code or any other identification means. The base surface 20 may be formed integral with the base 18 or may be defined by an insert member or the like which is attached to the vial base 18.

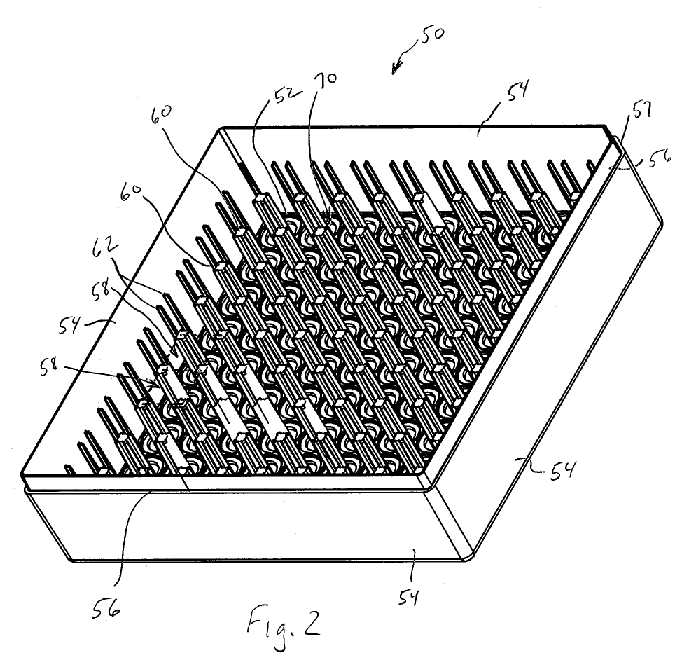

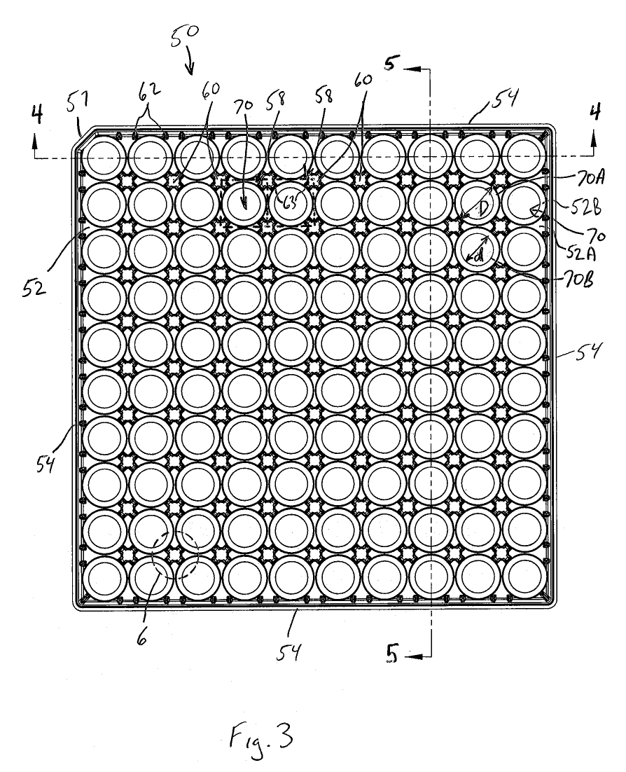

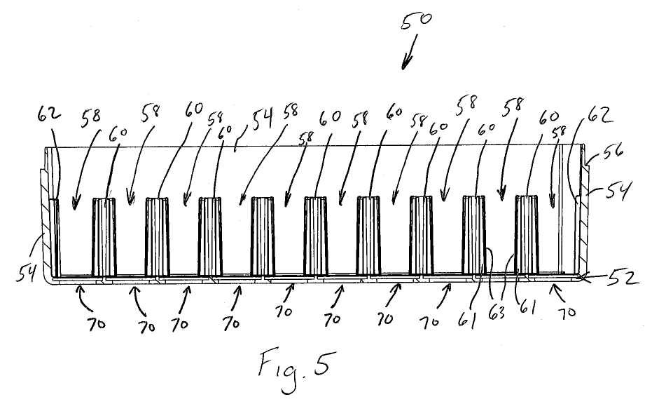

Referring to FIGS. 2-7, a storage rack 50 which is an exemplary embodiment of the present invention will be described. The storage rack 50 has a general box configuration with a support surface 52 and four interconnected side walls 54 extending therefrom. As shown in FIG. 2, each of the side walls 54 may define a receiving recess 56 for receiving and securing a lid (not shown) on the storage rack 50. One corner 57 of the storage rack 50 may be angled, see FIG. 3, to assure consistent alignment of the lid on the rack 50. The lid is preferably manufactured from a clear material to allow the vial assemblies 10 to be viewed without removal of the lid. Such may allow, for example, color coded sample identification.

A plurality of support members 60 and 62 extend from the support surface 52. The support members 62 have a partial configuration and extend along respective side walls 54. The support members 62 may be spaced from the support surface 52 and only extend along the side walls 54.

Each group of four adjacent support members 60, 62 define a respective vial receptacle 58. In the illustrated embodiment, one hundred vial receptacles 58 are defined within the storage rack 50 (two are indicated by dashed lines in FIGS. 2 and 3), although more or fewer may be provided as desired. Each vial receptacle 58 is sized to receive a vial 12 with the base 18 thereof supported on a respective portion of the support surface 52. While the vial receptacles 58 of the illustrated embodiment are defined by four support members 60, 62 having a ribbed post configuration as described below, the invention is not limited to such. More or less than four ribbed posts may be utilized per receptacle. Additionally, the vial receptacles 58 may be defined by other support members, for example, continuous walls extending between the side walls 54.

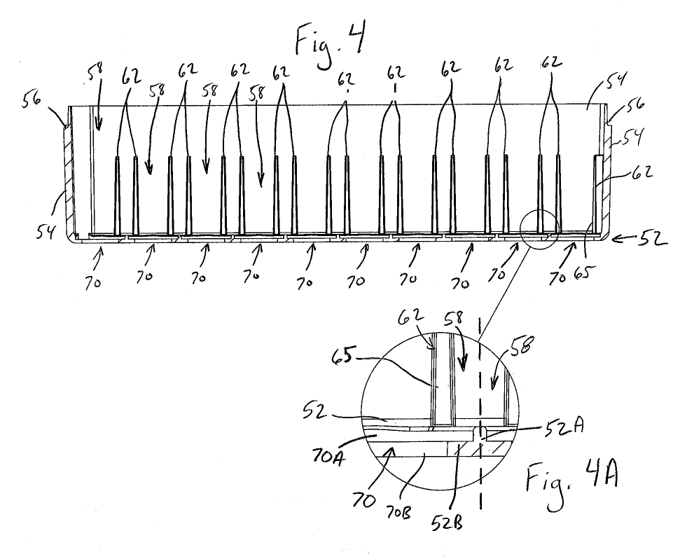

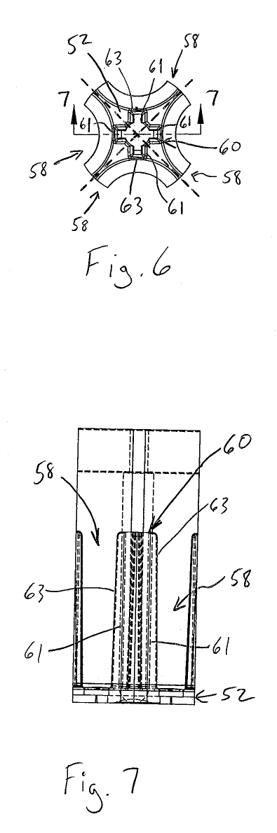

An illustrative support member 60 is shown in FIGS. 6 and 7. The support member 60 has a cross shape with four interconnected ribs 61. Each rib 61 has a substantially flat face 63 which extends into a respective vial receptacle 58. The rib faces 63 are preferably slanted moving from top to bottom such that each vial receptacle 58 is narrowest adjacent the support surface 52. The slanted faces 63 act to guide the vials 12 into the vial receptacles 58. Similarly, as illustrated in FIGS. 4 and 4A, the support members 62 are defined by individual ribs having a substantially flat face 65 which is slanted from top to bottom. The flat faces 63, 65 are configured to engage the flat surfaces 21 of the vial base 18, thereby limiting rotation of the vial 12 within the storage rack 50.

Referring again to FIGS. 2-4A, an opening 70 is defined through the support surface 52 within each vial receptacle 58. As illustrated in FIG. 4A, a portion 52A of the upper surface of the support surface 52 extends between adjacent vial receptacles 58. Each opening 70 is preferably concentric with the respective vial receptacle 58. In the illustrated embodiment, each opening 70 is stepped with a wider diameter portion 70A, with a diameter D, along the upper surface of the support surface 52 and a narrow diameter portion 70B, with a diameter d, along the bottom surface of the support surface 52. The stepped opening 70 defines a shoulder portion 52B of the support surface 52 within the wider diameter portion 70A of the opening 70. In the illustrated exemplary embodiment, the diameter D is approximately equal to the maximum width W of the vial base 18 while the diameter d is larger than the maximum width w of the identification indicia 22. With this configuration, the base 18 is received within the wider diameter portion 70A of the opening 70 and is supported on the shoulder portion 52B of the support surface 52 while the identification indicia 22 is completely exposed through the narrower diameter portion 70B of the opening 70.

While a stepped opening 70 is illustrated, such is not required. For example, the opening 70 may have a constant diameter. Preferably, the constant diameter would be approximately equal to the diameter d such that the base 18 supported on the upper surface of the support surface 52 while the identification indicia 22 is completely exposed through the opening 70.

With each of the identification indicia 22 completely exposed through the openings 70, can easily scan or otherwise read the identification indicia without removing the vials 12 from the storage rack 50. If desired, the entire rack of vials may be read at the same time.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed:

1. A vial storage rack for storing vials having a base, the storage rack comprising:
a support surface; and
support members positioned relative to the support surface to define a plurality of vial receptacles, each vial receptacle sized to receive and support a respective vial base,
wherein an opening is defined through the support surface in each vial receptacle, each opening having a size smaller than the size of the vial base.

2. The vial storage rack of claim 1 further comprising interconnected side walls extending about a perimeter of the support surface.

3. The vial storage rack of claim 1 further comprising a lid configured to engage the side walls and enclose the support surface.

4. The vial storage rack of claim 3 wherein the lid is transparent.

5. The vial storage rack of claim 3 wherein the side walls define a shoulder to support the lid.

6. The vial storage rack of claim 1 wherein the support members include a plurality of post members, with a subset of post members defining each vial receptacle.

7. The vial storage rack of claim 6 wherein each subset of post members includes four post members.

8. The vial storage rack of claim 6 wherein each post member includes a rib extending into each respective receptacle.

9. The vial storage rack of claim 8 wherein each rib defines a flat surface within the respective receptacle.

10. The vial storage rack of claim 9 wherein the flat surface is slanted from top to bottom such that each vial receptacle is narrowest adjacent the support surface.

11. The vial storage rack of claim 1 wherein each opening is concentric with the respective vial receptacle.

12. The vial storage rack of claim 1 wherein each opening has a stepped configuration with a wider portion along an upper surface of the support surface and a narrower portion along a bottom surface of the support surface.

13. The vial storage rack of claim 12 wherein the wider portion has a size larger than a size of the vial base and the narrower portion defines the size smaller than the size of the vial base.

14. The vial storage rack of claim 1 wherein the opening has a minimum size larger than a size of an identification indicia on a vial configured to be received in the respective vial receptacle.
